(19) United States
(12) Patent Application Publication
(10) Pub. No.: US 2012/0301688 A1
(43) Pub. Date: Nov. 29, 2012

(54) FLEXIBLE ELECTRONICS WIRING

(75) Inventors: Ricardo P. MIKALO, Heideblick (DE); Stephan D. KRONHOLZ, Dresden (DE); Matthias KESSLER, Dresden (DE)

(73) Assignee: GLOBALFOUNDRIES Inc., Grand Cayman (KY)

(21) Appl. No.: 13/115,583

(22) Filed: May 25, 2011

(51) Int. Cl. B32B 3/00; C23C 28/00; B32B 7/02; B32B 9/04; B32B 15/08

(52) U.S. Cl. 428/209; 428/457; 428/212; 205/183

(57) ABSTRACT

Devices are formed that combine low resistance for circuit needs with high flexibility for application needs. Embodiments include forming a low resistance layer on a substrate and forming a high flexibility conductive layer on the low resistance layer, wherein the high flexibility conductive layer provides for continuous conductivity of the low resistance layer. Embodiments include forming a pattern in the low resistance and high flexibility conductive layers simultaneously, or forming a pattern in the low resistance layer prior to forming the high flexibility conductive layer.

### TECHNICAL FIELD

The present disclosure relates to flexible microelectronics devices and is particularly applicable to flexible and/or organic electronics products.

### BACKGROUND

Flexible microelectronics have been widely used in display technologies, such as computers and communication systems with touch screens. Both organic and inorganic microelectronics require high resistance against breaks and cracks. Crack-free wiring levels require very thin or flexible material. However, the sheet resistance puts a limitation on the minimum thickness as the wires have to exhibit low resistances for proper conductivity. For this reason organic and, thus, inherently flexible materials are not suitable for most applications, and metal wiring layers have to be used. Typical thicknesses of such metal layers are in the range of 20 nanometers (nm) up to 500 nm, as currently applied in organic electronics. These metal wires, however, crack under frequent bending load as they are strongly limited in bending radius and life-time number of bends (having a bending flexibility of only 1° for a wire diameter of 20 microns (μm)). The cracks affect characteristics of transistors making applications of these flexible microelectronics limited in wide spread use including, for example, rollable displays such as e-paper, or wearable electronics.

A need therefore exists for methodology enabling fabrication of flexible microelectronics having a combination of low resistance and high flexibility, and the resulting product.

### SUMMARY

An aspect of the present disclosure is a method of fabricating flexible microelectronics devices by forming a laminate of a low resistance metal layer and a high flexibility conductive layer.

Another aspect of the present disclosure is a flexible microelectronics device including a low resistance metal layer and a high flexibility conductive layer.

Additional aspects and other features of the present disclosure will be set forth in the description which follows and in part will be apparent to those having ordinary skill in the art upon examination of the following or may be learned from the practice of the present disclosure. The advantages of the present disclosure may be realized and obtained as particularly pointed out in the appended claims.

According to the present disclosure, some technical effects may be achieved in part by a method of fabricating a flexible microelectronics device, the method including: forming a low resistance layer on a substrate; and forming a high flexibility conductive layer on the low resistance layer, wherein the high flexibility conductive layer provides for continuous conductivity of the low resistance layer.

Aspects of the present disclosure include forming a pattern in the low resistance and high flexibility conductive layers simultaneously. Further aspects include forming the pattern in the low resistance layer prior to forming the high flexibility conductive layer. Other aspects include forming the low resistance layer by sputter coating metals or inorganic layers with metallic conductivity, for example indium tin oxide, and forming the high flexibility conductive layer by electrochemically growing a polymer or a small molecule. Additional aspects include forming the low resistance layer by sputter coating metals, for example gold, and forming the high flexibility conductive layer by electrochemically growing polypyrrole, polypyrrole-derivatives, polythiophene, polythiophene-derivatives, or chemical, physical, or other deposition of benzene or related derivatives, for example naphthalenes, pentacenes, or hexacenes, which may or may not be side-chain substituted. Further aspects include forming a pattern in the low resistance and high flexibility conductive layers by photolithography or laser ablation. Other aspects include forming a pattern comprising conductive fingers and a connective bar. Additional aspects include forming the low resistance layer by sputter coating a metal, forming a pattern in the low resistance layer by photolithography and etching, and forming the high flexibility conductive layer by electrochemically growing a polymer or a small molecule. Further aspects include forming the low resistance layer by sputter coating gold and forming the high flexibility conductive layer by electrochemically growing polypyrrole, polythiophene, or pentacene on the patterned low resistance layer. Other aspects include forming a pattern comprising conductive fingers and a connective bar. Additional aspects include forming the low resistance layer having sheet resistance of less than 50 Ohm/square (sq.), and the high flexibility conductive layer having sheet resistance of more than 100 Ohm/sq. and bending flexibility of at least 100°.

Another aspect of the present disclosure is a device including: a substrate; a first layer formed on the substrate and having low sheet resistance; and a second layer formed on the first layer, the second layer having high flexibility and sufficient conductivity to provide for continuous conductivity of the first layer. The order of layers may also be reversed.

Aspects include a device, wherein the first layer comprises a metal and the second layer comprises polypyrrole, polythiophene, pentacene, or its derivatives. Further aspects include a device, wherein the first layer comprises gold and the second layer comprises tosylate doped polypyrrole. Other aspects include a device, wherein the first layer has sheet resistance of less than 50 Ohm/sq. and the second layer has sheet resistance of more than 100 Ohm/sq. and bending flexibility of 100°. Additional aspects include a device, wherein the first layer is patterned to form conductive fingers and a connective bar. The connective bar is only needed for electrochemical deposition of the flexible conductive layer. Other deposition methods may omit the need for a connective bar.

Another aspect of the present disclosure is a method including: sputter coating a metal layer having sheet resistance of less than 50 Ohm/sq. on a substrate; patterning the metal layer to form a wiring pattern; and electrochemically growing a layer of doped polypyrrole, polythiophene, or pentacene, having sheet resistance of more than 100 Ohm/sq. and bending flexibility of 100°, on the metal layer. Another aspect includes patterning the metal layer by photolithography and etching prior to electrochemically forming the layer of doped polypyrrole, polythiophene, or pentacene. An additional aspect includes patterning the metal layer and doped polypyrrole, polythiophene, or pentacene layer simultaneously using laser ablation.

Additional aspects and technical effects of the present disclosure will become readily apparent to those skilled in the art from the following detailed description wherein embodiments of the present disclosure are described simply by way of illustration of the best mode contemplated to carry out the present disclosure. As will be realized, the present disclosure is capable of other and different embodiments, and its several details are capable of modifications in various obvious respects, all without departing from the present disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawing and in which like reference numerals refer to similar elements and in which:

FIGS. 1A through 3A and 1B through 3B schematically illustrate side and top views, respectively, of a process flow for fabricating a flexible microelectronics device, in accordance with an exemplary embodiment;

FIGS. 4A through 6A and 4B through 6B schematically illustrate side and top views, respectively, of a process flow for fabricating a flexible microelectronics device, in accordance with another exemplary embodiment; and

FIG. 7 illustrates a cross-sectional view of a device when in use, in accordance with an exemplary embodiment.

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

The present disclosure addresses and solves the current problems of limited bending radius and cracking attendant upon frequent bending of flexible microelectronics. In accordance with embodiments of the present disclosure a wiring laminate is employed, including a low resistance metal layer and a high flexibility conductive layer, providing for a device that combines low resistance for circuit needs with high flexibility for various application needs. The conductivity of the flexible layer is sufficient to bridge microcracks that may occur in the metal layer.

Methodology in accordance with embodiments of the present disclosure includes forming a low resistance layer on a substrate and forming a high flexibility conductive layer on the low resistance layer, wherein the high flexibility conductive layer provides for continuous conductivity of the low resistance layer. The methodology also includes forming a pattern in the low resistance and high flexibility conductive layers simultaneously or forming a pattern in the low resistance layer prior to forming the high flexibility conductive layer.

Still other aspects, features, and technical effects will be readily apparent to those skilled in this art from the following detailed description, wherein preferred embodiments are shown and described, simply by way of illustration of the best mode contemplated. The disclosure is capable of other and different embodiments, and its several details are capable of modifications in various obvious respects. Accordingly, the drawings and description are to be regarded as illustrative in nature, and not as restrictive.

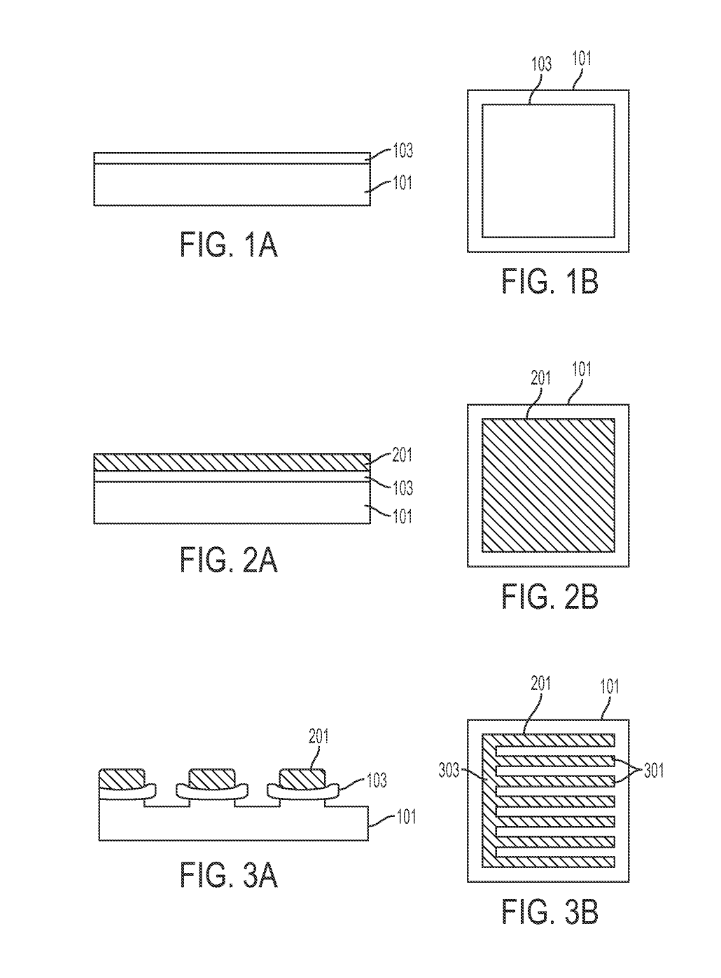

FIGS. 1A through 3A and 1B through 3B schematically illustrate side and top views, respectively, of a process flow for fabricating a device in accordance with an exemplary embodiment. Advering to FIGS. 1A and 1B, a low resistance layer 103 is formed on a non-conductive substrate 101, for example, by sputter coating, to a thickness of 20 nm to 500 nm. The low resistance layer may include a metal, for example noble metals, e.g., gold or platinum, or inorganic materials of metallic conductivity, such as indium tin oxide or others. Low resistance is defined as having a sheet resistance of less than 50 Ohm/sq.

As illustrated in FIGS. 2A and 2B, a high flexibility conductive layer 201 is formed on low resistance layer 103, for example, by electrochemical growth, to a thickness of 50 nm to 3000 nm. The high flexibility conductive layer may include a polymer, such as polypyrrole, a polypyrrole-derivative, polythiophene, a polythiophene-derivative, or a small molecule, such as pentacene. The polymer may also be a doped polymer, for example, doped polypyrrole or doped polythiophene. Tosylate or dodecylbenzosulfonate may be used as dopants. Alternatively, the high flexibility conductive layer may be formed by chemical, physical, or other deposition of benzene or related derivatives, for example naphthalenes, pentacenes, and hexacenes, which may or may not be side-chain substituted. The high flexibility conductive layer may have a sheet resistance of more than 100 Ohm/sq. High bending flexibility is defined as an ability to bend at least 100° for a wire having a 20 nanometer (nm) diameter.

Adverting to FIG. 3A, both layers 103 and 201 are patterned simultaneously, for example, by laser ablation or by lithography and reactive ion etching (RIE). The pattern may include conductive fingers 301 and connective bar 303.

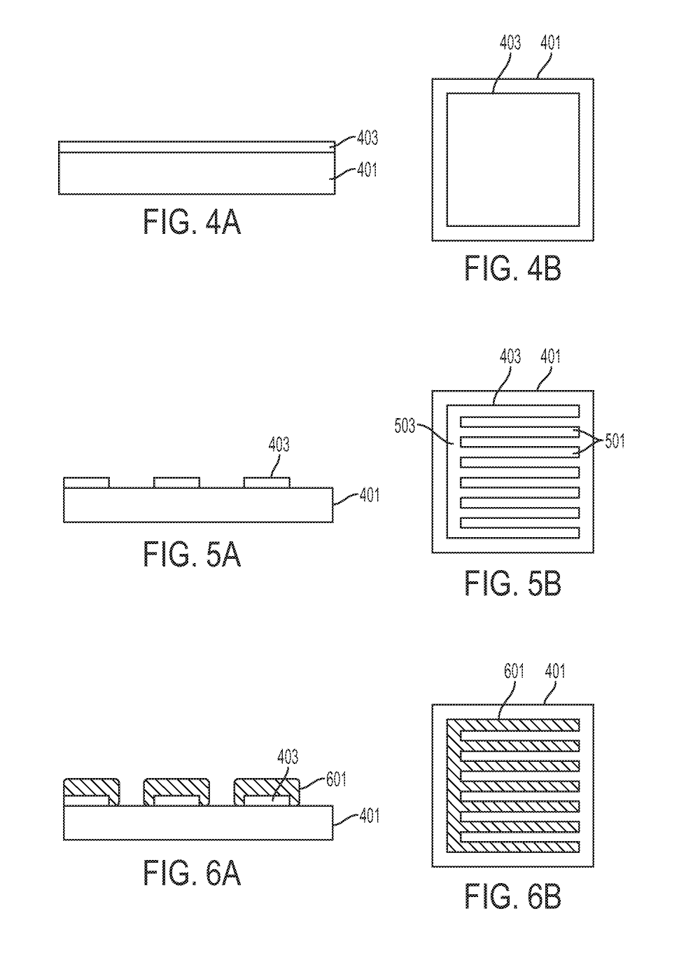

FIGS. 4A through 6A and 4B through 6B schematically illustrate side and top views, respectively, of a process flow for fabricating a device in accordance with another exemplary embodiment. Adverting to FIGS. 4A and 4B, a low resistance layer 403, similar to low resistance layer 103 of FIGS. 1A and 1B, is formed on non-conductive substrate 401, for example, by sputter coating, to a thickness of 20 nm to 500 nm. As illustrated in FIGS. 5A and 5B, low resistance layer 403 is subsequently patterned, for example, by photolithography and etching. The pattern may include conductive fingers 501 and connective bar 503.

Adverting to FIGS. 6A and 6B, a high flexibility conductive layer 601, similar to layer 201, is then formed on patterned low resistance layer 403, for example, by electrochemical growth, to a thickness of 50 nm to 3000 nm. As conductive fingers 501 remain electrically connected sideways by connective bar 503, the electrochemical polymerization takes place only on the electrodes and is therefore self-aligned.

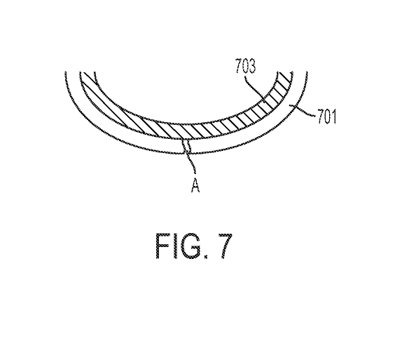

FIG. 7 illustrates a cross sectional view of a device when in use, according to an exemplary embodiment. As illustrated, a microcrack A may occur within low resistance layer 701. Microcracks have a width of not more than 1 μm along the lengthwise direction of the metal wire and are as long as the diameter or width of the metal wire. The microcracks are bridged by the high flexibility conductive layer 703 that allows for the device to function with microcracks present. For example, in a wiring having a 10 millimeter (mm) length, 5 μm width, and formed of a low resistance gold layer having thickness 50 nm and 7 Ohm/sq. sheet resistance and a high flexibility conductive layer of tosylate doped polypyrrole having 3 kOhm/sq. sheet resistance, the total resistance of the intact wire is 14 kOhm. With 1 microcrack having length of 1 μm, the resistance increases by 0.6 kOhm, or by 4.3%. Since the increase in resistance is relatively small, the wiring maintains a low resistance, and the flexible conductive layer insures the electrical connection between the split portions of the wiring, allowing the wiring to continue functioning. Many cracks would cause higher resistance increases. However, the number of possible cracks along one wire depends on the length of the wire itself, and it is assumed that there is a maximum number which cannot be exceeded due to bending radius limitations and mechanical properties of the low resistance layer.

The embodiments of the present disclosure can achieve several technical effects, including microelectronics having high flexibility and robustness resulting in the increased bending radius and lifetime number of bends, combined with low resistance that ensures a desired level of conductivity. Additionally, the methodology provides for simple patterning and low production cost. The present disclosure enjoys industrial applicability in any of various types of flexible microelectronics including rollable displays, wearable electronics, biomedical devices, automotive applications and sensors.

In the preceding description, the present disclosure is described with reference to specifically exemplary embodiments thereof. It will, however, be evident that various modifications and changes may be made thereto without departing from the broader spirit and scope of the present disclosure, as set forth in the claims. The specification and drawings are, accordingly, to be regarded as illustrative and not as restrictive. It is understood that the present disclosure is capable of using various other combinations and embodiments and is capable of any changes or modifications within the scope of the inventive concept as expressed herein.

What is claimed is:

1. A method comprising:
forming a low resistance layer on a substrate; and
forming a high flexibility conductive layer on the low resistance layer, wherein the high flexibility conductive layer provides for continuous conductivity of the low resistance layer.

2. The method according to claim 1, comprising forming a pattern in the low resistance and the high flexibility conductive layers simultaneously.

3. The method according to claim 1, comprising forming a pattern in the low resistance layer prior to forming the high flexibility conductive layer.

4. The method according to claim 2, comprising:
forming the low resistance layer by sputter coating metals or inorganic layers with metallic conductivity; and
forming the high flexibility conductive layer by electrochemically growing a polymer or a small molecule or by sputter depositing a small molecule.

5. The method according to claim 4, comprising:
forming the low resistance layer by sputter coating gold; and
forming the high flexibility conductive layer by electrochemically growing polypyrrole, polythiophene, pentacene, or its derivatives.

6. The method according to claim 2, comprising forming a pattern in the low resistance and the high flexibility conductive layers by photolithography or laser ablation.

7. The method according to claim 2, comprising forming a pattern comprising conductive fingers and a connective bar.

8. The method according to claim 3, comprising:
forming the low resistance layer by sputter coating a metal;
forming a pattern in the low resistance layer by photolithography and etching; and
forming the high flexibility conductive layer by electrochemically growing a polymer or a small molecule.

9. The method according to claim 8, comprising:
forming the low resistance layer by sputter coating gold; and
forming the high flexibility conductive layer by electrochemically growing polypyrrole, polythiophene, or pentacene on the patterned low resistance layer.

10. The method according to claim 9, comprising forming a pattern comprising conductive fingers and a connective bar.

11. The method according to claim 6, comprising forming the low resistance layer having sheet resistance of less than 50 Ohm/sq., and the high flexibility conductive layer having sheet resistance of more than 100 Ohm/sq. and bending flexibility of at least 100°.

12. The method according to claim 9, comprising forming the low resistance layer having sheet resistance of less than 50 Ohm/sq., and the high flexibility conductive layer having sheet resistance of more than 100 Ohm/sq. and bending flexibility of at least 100°.

13. A device comprising:
a substrate;
a first layer formed on the substrate and having low sheet resistance; and
a second layer formed on the first layer, the second layer having high flexibility and sufficient conductivity to provide for continuous conductivity of the first layer.

14. The device according to claim 13, wherein the first layer comprises a metal and the second layer comprises polypyrrole , polythiophene, pentacene, or its derivatives.

15. The device according to claim 14, wherein the first layer comprises gold and the second layer comprises tosylate doped polypyrrole.

16. The device according to claim 13, wherein the first layer has sheet resistance of less than 50 Ohm/sq. and the second layer has sheet resistance of more than 100 Ohm/sq. and bending flexibility of 100°.

17. The device according to claim 13, wherein the first layer is patterned to form conductive fingers and a connective bar.

18. A method comprising:
sputter coating a metal layer having sheet resistance of less than 50 Ohm/sq. on a substrate;
patterning the metal layer to form a wiring pattern; and
electrochemically growing a layer of doped polypyrrole, polythiophene, or pentacene, having sheet resistance of more than 100 Ohm/sq. and bending flexibility of 100°, on the metal layer.

19. The method according to claim 18, comprising patterning the metal layer by photolithography and etching prior to electrochemically forming the layer of doped polypyrrole, polythiophene, or pentacene.

20. The method according to claim 18, comprising patterning the metal layer and doped polypyrrole, polythiophene, or pentacene layer simultaneously using laser ablation.
